(19) United States
(12) Patent Application Publication
(10) Pub. No.: US 2007/0087686 A1
(43) Pub. Date: Apr. 19, 2007

(54) Audio playback device and method of its operation

(75) Inventors: Jukka Holm, Tampere (FI); Juha Arrasvuori, Tampere (FI); Antti Eronen, Tampere (FI); Raymond Ko, Burnaby (CA); Michael McKay, Frederiksberg (DK)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/252,978

(22) Filed: Oct. 18, 2005

(51) Int. Cl. H04H 7/00

(52) U.S. Cl. 455/3.06

(57) ABSTRACT

The invention relates to mobile audio playback devices and methods of its operation for enhanced music and sound experience for mobile devices. To provide stereo and surround sound, the present invention provides an audio playback device with a receiving means for receiving multi-channel audio data, obtaining means connected to the receiving means, for obtaining first channel audio data from the multi-channel audio data for playback on the audio playback device, and playback means having at least one loudspeaker, and being connected to the obtaining means for outputting the first channel audio data. The other not selected audio channels or all received audio data may be transferred to other terminals for playback or may be discarded.

### TECHNICAL FIELD

The invention deals with enhanced music and sound experience for mobile devices. Especially, stereo and surround sound is created by using the integrated hands-free loudspeakers of several mobile devices located at spatial distances, and playing one (or a subset of) audio channel(s) on each device. In this way, the audio and music content can be shared, while at the same time improving the sound experience. Additionally, other sound systems (subwoofer, home stereo) may be included in the sound sharing experience. The present invention is also related to mobile games and multi-channel sound.

### BACKGROUND OF THE INVENTION

Since the days of mobile portable tape players the use of mobile devices for music consumption is spreading. The MP3 file format and the MP3 players have opened up a revolution in the mobility and accessibility of digital music and audio. When listening to the music while on the move (being mobile) often requires the user to wear headphones or use the integrated hands-free speakers. New stereo-speaker phones are being introduced to give better quality but the range of the stereo field is quite low due to the intrinsic small distance of the speakers in the mobile device.

The present invention is also related to different multi-channel audio playback systems, such as the “X.Y” sound systems. In an X.Y sound system the “X.” represents the number of different loudspeakers used for detectable/directionable audio signals and the “.Y” is related to the number of sub woofer loudspeakers.

Actually there are different Multi-channel speaker formats on the marked, such as (two channel) stereo (2.0), (four channel) Quattro (4.0), (four channel) LCRS, the (six channel) 5.1, and the (eight channel) 7.1 sound system.

The 5.1 system is a six-channel format popular in home and movie theaters. This format uses left, center, and right front speakers, and left and right surround speakers, as well as a sub-woofer (i.e. the 0.1). These speakers can be satellite speakers or full range speakers. The sub-woofer plays only frequencies from around 120 Hz and below, a frequency range in which a human can not localize the source of the sound i.e. the loudspeaker.

The 7.1 system is a motion picture format which consisting of five full-range front channels, two surround channels and one channel called an LFE (low frequency environment) that is sent to a subwoofer. The 7.1 system is also a consumer format with additional side or front channels.

Another four-channel sound system is the 3.1 “LCRS” system consisting of a Left-, Center-, Right- and Subwoofer-loudspeaker. This system is also known as the Dolby Pro Logic speaker format.

The five channel sound system is the 4.1 “LCRRS” system consisting of a Left-, Center-, Right-, Rear- and Subwoofer-loudspeaker.

According to several references the center speaker is the primary carrier of dialogue and should therefore be the same quality as the left and right front speakers. Ideally, it should be the exact same speaker, or at least matched in quality and power. Placement of this speaker may be best right on top or directly below the video screen/display.

It is also known to simulate 3D audio signals with the built-in stereo speakers of mobile terminals. However these solution only provide a limited range of surround sound coverage. That is, persons have to be very close to the mobile terminal to enjoy 3D sound experience. However, there is a natural limit to the stereo or “3D-sound” functionality of any single device due to the physical size restrictions of mobile devices.

### SUMMARY OF THE INVENTION

All the above approaches for a multi-channel audio playback have in common that they are not suitable for the use with mobile terminal devices as mobile phones, or handheld computers due to small sizes of mobile terminal devices. Therefore, it is desirable to have a mobile audio playback system capable of playing back multi-channel audio data.

It is desirable to improve the sound quality of audio playback of mobile devices. It is especially desirable to improve the usage of multi-channel sound reproduction in mobile audio playback and games devices.

It is also desirable to overcome the lack of sufficient capacity in single mobile phones for sharing audio content. It is also desirable to enable e.g. more than three people to enjoy audio signals from a mobile device such as a mobile phone without the necessity to increase the sound level inadequately.

It is also desirable to enable more than just single persons to use a portable surround sound system. It is desirable to enable people to share the experience of listening to audio signals from mobile devices.

According to a first aspect of the present invention a method for playing back audio data on an audio playback device such as an audio playback enabled mobile phone is provided. The method comprises receiving multi-channel audio data, in an audio playback device, obtaining first channel audio data from said multi-channel audio data for playback, and playing back said first channel audio data via at least one loudspeaker of said audio playback device.

In a basic embodiment an audio playback device such as a mobile telephone receives multi-channel audio data such as an audio stream. The phone selects or generates first channel audio data from said received multi-channel audio data (for example a single or two channels of a X.Y sound system) and outputs said channel(s) via built-in loudspeakers.

This basic implementation may be interpreted as a first audio playback device that outputs only a part of all available or generated audio channels of received multi-channel music, movie or game audio data. This may be for example implemented as a gaming enabled audio playback device, gaming terminal or gaming phone that receives multi-channel audio data from a game application running on said gaming terminal and reproduces e.g. only the center speaker channel of said multi-channel audio data. This embodiment may be interpreted as providing only a restriction in the audio experience by reproducing only a single-track instead of all available multi-channel audio data. However, the benefit of the invention will become clearer with respect to the following embodiments.

Another basic implementation may be interpreted as second playback device that outputs only a part of all available or generated audio channels of received multi-channel music, movie or game audio data. This other basic embodiment may be implemented as a mobile audio playback device that receives a multi-channel audio data from e.g. another audio player device (e.g. a music player or a gaming terminal) and reproduces e.g. only the e.g. left rear speaker channel of said received multi-channel audio data. That is, this may be embodied as a satellite box of a multi-channel sound system that selects or generates its own dedicated (single) audio channel from received multi-channel audio data.

This embodiment seems again to represent only a restriction in the audio experience of by reproducing only a single-track of multi-channel audio data; the invention will become clear when it is expected that for each channel of e.g. a 5.1 audio signal a single device is being provided. This embodiment represents a method to be executed on a mobile terminal that receives e.g. a stereo stream, generates a single channel e.g. left rear of a 5.1 surround sound system and outputs this channel via built-in loudspeakers. It is also envisaged to execute this embodiment in a mobile terminal that receives e.g. a stereo stream, generates the left and right rear channels of an “X”0.1 surround sound system and outputs this channels via a or a set of built-in loudspeakers. This embodiment can serve as a set of e.g. rear or middle loudspeakers for outputting both side signals simultaneously when the device is a stereo device. Six combined devices may serve as a fully-fledged 5.1 sound system. In such a 5.1 system each of the devices receives the same audio data, and each device generates or selects its own single audio channel from the received audio data and outputs this channel via an internal (or external) loudspeaker.

It should be noted that the expressions “first audio playback device” and “second audio playback device” might be used in respect to a single device or with respect to a playback system. The “second audio playback device” could be defined as a device that receives audio data via wired (or wireless) short-range data transfer connection. The “first audio playback device” could be defined as a device that may receive multi-channel audio data via a long-range audio data connection, from an internal audio player or from any internally executed application producing an audio output. Similarly, in an audio playback system it is expected that there is one “first audio playback device” serving as audio player and a number of (possibly different) second audio playback devices serving as satellite loudspeakers.

In an example embodiment said method for playing back audio data further comprises receiving an input indicative of which channel of said multi-channel audio data is to be obtained, and obtaining said first channel audio data from said received multi-channel audio data in accordance with said received input.

This embodiment serves to select which of the external devices reproduces a certain audio channel of (commonly) received multi-channel audio data (on said first or second audio playback devices). This embodiment may serve to assure that all receiving devices are not playing e.g. the left rear channel of a multi-channel audio system simultaneously. This embodiment may serve to enable a user to ensure by user input that certain device e.g. at the right front position does not play the left rear channel of a multi-channel audio system.

It is possible to use e.g. direct user input at each device to select the channel(s) to be reproduced. It may also be possible to utilize a near field radio linkage to select the playback of given audio file channels. By playing only left channel in some devices and right channel in other devices in a near field playback system, more true stereo sound can be obtained than by any other system. It is also possible to simplify the system by utilizing a “magic-touch RFID concept” (RF ID touching the devices) or a push-Bluetooth functionality (wherein one user “suggest” the sharing and another user accepts, which initiates the transfer) to make the system user-friendly.

This embodiment provides a simple way to involve many (even different) devices in playing/sharing audio/music. This is enabled by transferring of audio/music and later splitting the channels of the audio signal and synchronizing the audio/music for playback using the built-in loudspeakers of audio playback devices. In case of mobile phones the hands-free speakers of the phones may be used for music replay. The users will have to determine themselves by user input if their phone should play right/left/back channel in a surround sound transmission. The feature is aimed at gatherings of people, who want to share a music experience e.g. at a dinner in the park, at a ride on a train, when waiting in the classroom for teachers.

In case the multi-channel audio data are present as MIDI (Music Instrument Digital Interface) audio data the present invention may be used to play back single (or multiple) channels on each device (capable or playing back MIDI data) enabling the playback of MIDI sound with instruments distributed on several devices, forming a kind of MIDI orchestra. The present invention may be directed to a device capable of selecting only a few channels of an orchestral MIDI stream for playback on the device. In this case the devices have to be capable of processing and/or playing back MIDI files.

In another example embodiment of the present invention the method further comprises obtaining second channel audio data at the first audio playback device for playback on at least one second audio playback device, and sending said obtained second channel audio data to said at least one second audio playback device.

It should be noted that the expressions “first channel audio data ” and “second channel audio data” may be used in respect to a single device or with respect to the system. In the audio system the “second channel audio data” sent by a device may be received by another device as “first channel audio data”. Similarly, in an audio playback system the “first channel audio data” generated/selected by a certain device may (or is even expected to) be different for each single audio playback device in the audio system. The first channel audio data or the second channel audio data may each comprise a number of single dedicated audio channels, but not all audio channels that are selected/generated for an audio playback system. The first channel audio data may comprise e.g. the left and right channels of a surround sound system if the device is capable of using built-in stereo speakers. The first channel audio data can also comprise e.g. the center channel and the subwoofer channel of a surround sound system if the device is capable of operating a built-in or e.g. a connected subwoofer speakers. The second channel audio data may comprise e.g. the left and right rear channels of a surround sound system if the device is capable of using built-in stereo speakers. That is, in the audio playback system according to the invention there is no single device that plays/outputs all channels of the audio system.

This embodiment is directed to a device that is capable of generating or selecting different audio channels from received multi-channel audio data, reproduces at least one (first) channel with built-in speakers and transfers other generated (second) channels to remote playback devices. In this embodiment each device receives its individual second channel audio data for playback. In this embodiment a master device generates all single channels and plays one channel and sends (at least) one to a remote satellite audio playback device. In contrast to e.g. a Bluetooth headset the device itself still uses its loudspeaker to reproduce an audio channel, and the headset does not reproduce all audio channels of the multi-channel audio data.

In yet another example embodiment of the present invention said first channel audio data played back via at least one loudspeaker of said first audio playback device is the audio channel of a center speaker of multi-channel audio playback system.

When using external multi-channel sound systems, dialogue and other center speaker sounds come from a “natural” location next to the player, which is important for perceiving and understanding dialogues in games. This embodiment is especially directed to electronic mobile gaming devices wherein a user actually holds the device in the hands and looks on a display of the device while playing a game. This embodiment represents a novel approach for adding multi-channel sound support to mobile games. The center audio channel is played using a mobile (game/music) phone's own loudspeaker(s), while other channels are played using the external multi-channel sound system. The connection to the second audio playback devices of the external system can be done using e.g. a cable or streaming the data wirelessly via a short-range radio connection such as Bluetooth or WLAN. Due to bandwidth restrictions the multi-channel audio data may have to be efficiently compressed.

In another additional example embodiment, the method further comprises outputting said second channel audio data with said at least one second audio playback device.

With the outputting of the first channel audio data on a first device and a second channel audio data on a second remote device, the present invention can utilize the increased distance between these devices to generate a better surround sound field/effect. It should be noted that the same audio playback enabled mobile telephones or mobile gaming devices may be used as the first and second audio playback devices. An aspect of the invention is to achieve an improved audio playback for all participating devices by restricting the ability of each single device in combination with an interaction between the devices. Each device is restricted to one or two audio channels and all devices are brought into line to achieve a composed surround audio playback experience for a larger number of participating people.

This embodiment is related to a method to be executed on an audio output system comprising at least e.g. one master (first audio playback) device and one slave (second audio playback) device both outputting audio data of different audio channels. The proposed system comprises at least two devices wherein the first one generates/selects different audio channels for the playback on each device (including itself). Any group of people having a number of (suitable) audio playback devices according the present invention can use them as portable surround sound system according to the present invention. The invention further extends the possibilities of enjoying and sharing music content with friends.

This embodiment represents a unique way to share music, that enables the creation of a real surround sound music system anytime, anywhere whenever enough terminal devices can be gathered together with freedom from any limitations of known solutions. The invention describes a novel approach for adding multi-channel sound support to mobile games. The center/left/right/front/rear audio channel is played using a mobile phone's or gaming terminal's own loudspeaker(s) (serving as the first audio playback device), while other channels are played using the external multi-channel sound system (comprising a number of second audio playback devices). The connection from the first audio playback device to the second audio playback devices of the external system may be done by cable or by streaming the data wirelessly over a short-range data transfer connection such as Bluetooth or WLAN. Due to bandwidth restrictions it may be required that the multi-channel audio data have to be efficiently compressed.

By distributing the content by Bluetooth and using the near-field radio to synchronize the playback, more sound is played when more users join the group.

It is also possible to use stereo sharing, thus assigning either the left or the right channel to any of the involved audio playback devices. It is also envisaged to create a “center” audio stream combining right and left channel on one device, and playing left and right on other devices (in a scenario with more than 2 devices).

According to another example embodiment said method further comprises transferring said received multi-channel audio data from said first audio playback device to at least one second audio playback device. It is envisaged to share the complete audio content with all devices so that the broadcasting of the audio content is possible. This embodiment may be executed on a single audio playback device.

In another example embodiment of the present invention, the method further comprises obtaining at least one second channel audio data from said transferred multi-channel audio data at said at least one second playback device, for playback on said at least one second audio playback device, and outputting said second channel audio data with said at least one second audio playback device.

In this embodiment two audio playback devices act together as an audio playback system to enable a user to use a surround sound playback system with many people and a number of audio playback devices.

In this embodiment the first audio playback device serves as a local short-range radio broadcast station, and transmits all channels of the multi-channel audio data to all second audio playback devices. Each of the second audio playback devices receives all channels of the multi-channel audio data and filters or generates only its own audio channel for a combined multi-channel audio output. This embodiment has the additional advantage that each device has only to generate a single channel, and the calculation resources are better distributed over the whole system. Another advantage resides in the restricted bandwidth requirement for the whole system, as it is simpler to broadcast the raw multi-channel audio data then to generate and broadcast every single channel of the e.g. eight audio channels of a 7.1 surround sound system.

Both principles of the invention, the transfer of the multi-channel audio data and the transfer of the second channel audio data, have in common that multiple customer electronics devices are used together to setup a portable surround sound system. The invention utilizes e.g. near-field radio linkage to synchronize the playback of given audio files. By playing only left channel in some playback devices and right channel in other playback devices in the near field playback system, more true stereo (Quattro-, surround-, X.Y-) sound can be obtained than by any other system.

The present invention involves in a simple way many different devices for playing/sharing music, which is enabled by the transfer of the music data and a synchronized music playback using the built-in hands free speakers of e.g. mobile or cellular phones. The users will have to determine for themselves if a certain phone should play right/left/back channel in a surround sound transmission. The feature can be used at all gatherings of people who want to share a certain audio/music experience at dinner in the park at a ride on a train when waiting e.g. in a classroom.

In another example embodiment of the present invention said fist channel audio data and/or said second channel audio data are obtained by selecting said first channel audio data and/or said second channel audio data from said received multi-channel audio data at said first/second audio playback device.

This embodiment is especially useful if the multi-channel audio data comprise already a single channel for each of the playback devices, so that it is sufficient to delete/mute all channels not intended for playback in the first playback device or one of the second playback device(s).

By selecting a certain audio track from a number of different received audio tracks e.g. the left channel of stereo audio data the use of (power and calculation) resources is restricted to a minimum. In case of e.g. 5.1 surround sound audio data, the center channel may be played back via the loudspeaker(s) of a first mobile phone, while the left/right, front/rear, and base channels are transferred to and replayed by external audio output devices such as external loudspeakers, audio playback devices and/or other mobile phones. In an example embodiment said external audio output devices may be embodied as a low power radio receiver, an amplifier and at least one connected loudspeaker. In this embodiment one device serves as audio playback device for all audio channels, plays back one (or two) selected channel(s), and transfers the other audio channels to satellite playback devices.

In yet another example embodiment of the present invention said first/second channel audio data are obtained by generating said first/second channel audio data from said received multi-channel audio data.

In this embodiment the number of audio channels or audio tracks in the received multi-channel audio data is different from the number of playback devices or from the number of audio channels that maybe output by said playback devices. To enable a nearly optimal sound experience, the required or available number of audio channels that may be output has to be generated by said first and/or second devices from said multi-channel audio data. In case there are fewer playback devices available than tracks/channels are provided in the multi-channel audio data, the system may only play back a smaller number of audio playback channels. This smaller number of audio playback channels may be generated by combining some of the tracks for playback via a single device. In case of e.g. virtual 5.1 surround sound, audio data of the center channel and all the other left/right/front/rear, and bass channels are generated from e.g. only a two-channel stereo audio data. It should be noted that the generation of said audio data may be performed in a centralized manner i.e. one device receives the audio data, generates the first and second channels and transfers them via wired or wireless connections to external audio playback devices. It is also possible to use a distributed channel selection or generation system, wherein each of the first and second audio playback devices generates its own audio channel(s) for playback.

According to another example embodiment of the present invention, said multi-channel audio data are received in said first audio playback device from an audio internal or external audio data storage. The internal or external data storage may be a memory card, a memory of a digital music player in said first audio playback device, a CD- (DVD- or the like) type digital storage media or e.g. a hard coded audio chip. That is, this embodiment of the invention may be considered to be executed on a terminal device with music/audio or even video player capability. A device to execute may comprise e.g. a DTS surround sound-, DVD-Audio- (DVA-), Hyper CD-, MP3-, .ogg-, .wav-, .aif-, .aiff-, .au-, .wma-, .ra-, .ram-, RealAudio-, AAC-, .m4a- and/or, AC3-file player.

In another example embodiment of the present invention, the method for playing audio data further comprises synchronizing said audio playback of said first channel audio data on said first audio playback device with the audio playback of said (at least one) second channel audio data on said at least one second audio playback devices.

In case of e.g. a simple selection of single audio channels, this synchronization may be achieved by determining a signal delay coefficient between the reception of the audio data and the point in time these data are outputted as an acoustic audio signal. There may be considerable differences caused e.g. by compression and decompression steps the playback in the “faster” devices to synchronize with the devices with the highest delay time. However, this approach is not suitable for the use with devices comprising non-constant delays in generating an acoustic output signal.

In another example embodiment of the present invention the method further comprises providing said obtained first and second channels audio data with synchronization markers, to enable synchronized playback. This embodiment can be used to synchronize the audio streams or audio channels with each other. It is also envisaged to synchronize the acoustic output signals of the single audio data channels with e.g. the video content of a film or game displayed on said first device. It is also envisaged to synchronize the acoustic output signals of the single audio data channels with e.g. the Bluetooth bit stream used to transfer the (multi-channel or second channel) audio data. It is also contemplated to adjust the playback of the first and second audio channels with respect to a certain time reference. It is especially contemplated to synchronize the playback with a transfer clock signal.

In yet another example embodiment, the method of the present invention further comprises compressing said multi-channel and/or second channel audio data at said first audio playback device before transferring them to said at least one second audio playback device.

In just another example embodiment, the method of the present invention further comprises decompressing said transferred compressed multi-channel or second channel audio data at said at least one second audio playback device.

The advantages of a compression/decompression procedure with respect to the bandwidth requirements should be considered as being clear. In view of different bandwidth restrictions of some wireless data exchange devices it should be clear that transferring smaller amounts of data might circumvent these restrictions. The connection to an external system is done using e.g. a cable or streaming the data wirelessly over Bluetooth or WLAN. Due to bandwidth restrictions the multi-channel audio data needs to be efficiently compressed. It is also contemplated to use different transfer media to be able to transfer high bandwidth to a number of different transfer media or interfaces such as infrared, cable, Bluetooth and/or WLAN to provide different types of connections to different connected second audio playback devices.

In still another example embodiment of the present invention, the method further comprises executing game software, outputting video data of said executing game software on a display, and providing said multi-channel game audio data as said received multi-channel audio data. Receiving user input for gaming may also extend the method and executing said game according to said user input. The multi-channel audio data can comprise game sounds such as sound effects, speech output and background music. It is also envisaged to connect a game terminal (as first audio playback device) to an external audio system (comprising e.g. a number of different audio enabled mobile phones as second audio playback devices).

This embodiment represents a novel approach for adding multi-channel sound support to mobile games. The center audio channel can be played using the mobile gaming terminal's or the mobile game phone's own loudspeaker(s), while other channels are played using the external multi-channel sound system.

In another example embodiment of the present invention the method further comprises receiving display information, outputting display information on a display, and transferring display information to other devices. It should be noted that this embodiment is directed to an application wherein a device may in addition to the above mentioned audio stream may also generate additional video information for a kind of 3D video playback. The term display information has been selected to encompass video stream, or other video/display information such as, e.g., the rear-view mirror or the exterior mirrors of a racing car in a race car game or in a DVB-H video stream of a NASCAR or INDICAR race television broadcast.

This embodiment may also be described as a receiving method for playing back audio/video data on an audio/video playback device such as an audio/video playback enabled mobile phone. The method comprises receiving multi-channel audio/video data, in an audio/video playback device, obtaining first channel audio/video data from said multi-channel audio/video data for playback, and playing back said first channel audio/video data via at least one loudspeaker and display of said audio playback device. It should be clear that this embodiment extends all other steps of the method of the present invention disclosed only with respect to audio data also to audio and video data. That is the method is extended to encompass also storing, receiving, handling, compressing, transferring, decompressing selecting, generating outputting (multi-channel) audio/video data.

As in the case of the audio only implementation, a user may follow the main scene while other terminal devices serving as satellite speakers may serve to display visual side effects such a “blink” information perceptible only in the periphery vision of the eye. It is also envisaged to use e.g. in case of music videos the other terminals to play back a background light in a shade and intensity of display content of the main display. It may also be envisaged to implement a kind of a color organ or clavilux as a light effect by the displays of satellite speaker devices. Especially the field of music and music video playback opens nearly unrestricted possibilities from sing along or karakoke features in which the displays of the satellite devices may display an actual song text to facilitate understanding. It may even be possible to economize organs and songbooks in liturgical applications.

According to yet another aspect of the invention, a software tool is provided comprising program code means for carrying out the method of the preceding description when said program product is run on a computer or a network device.

According to another aspect of the present invention, a computer program product downloadable from a server for carrying out the method of the preceding description is provided, which comprises program code means for performing all of the steps of the preceding methods when said program is run on a computer or a network device.

According to yet another aspect of the invention, a computer program product is provided comprising program code means stored on a computer readable medium for carrying out the methods of the preceding description, when said program product is run on a computer or a network device.

According to another aspect of the present invention, a computer data signal is provided. The computer data signal is embodied in a carrier wave and represents a program that makes the computer perform the steps of the method contained in the preceding description, when said computer program is run on a computer, or a network device.

Preferably the computer program and the computer program product are distributed in different parts and devices of the network i.e. the first and second audio playback devices. The computer program and the computer program product run in different devices of the network. Therefore, the computer program and the computer program product may have to be different in abilities and source code.

According to another aspect of the present invention an audio playback device is provided. The audio playback device comprises a receiving means, obtaining means, and playback means having at least one loudspeaker. The receiving means is provided for receiving audio data. The obtaining means is connected to said receiving means, and is provided for obtaining a first channel audio data from said multi-channel audio data for playback on said audio playback device. The playback means with at least one loudspeaker is connected to said obtaining means for receiving obtained audio channel from the obtaining means. The at least one speakers is provided to output said first channel audio data, as an acoustic signal, i.e. music, speech sound effects and the like.

This basic embodiment represents one of the second audio playback devices cited in the description of the method of the present invention. The second device is capable of receiving multi-channel audio data, generate of select one, two (front-, middle-, or rear-stereo) or three (front-, middle-, or rear-stereo and sub-woofer) audio channels and output them as an acoustic signal via built-in or connected speakers.

The receiving means can be an interface to a music data storage or e.g. an interface to another internal component or external device such as a multi-channel audio player device, to be able to receive a multi-channel audio data as e.g. an audio data stream. The multi-channel audio data stream may comprise two or more single audio channels. The obtaining means can be embodied as a selector circuit or e.g. as a “virtual Dolby surround” or virtual surround sound generator. In the field of audio devices such sound enhancing devices starting from “bass boost” to virtual 7.1 surround sound to generate additional audio channels from a given set of audio data is known in the art. It is also known to combine the audio data of two different channels for the output of e.g. a stereo signal via a mono speaker. It is known in the art to combine single component of channels to adapt a given number of audio channels to a fix number of speakers. One of the merits of the present invention resides in the capability to generate a (nearly) arbitrary number of audio channels from audio data with an arbitrary number of audio channels and the additional capability to select some of them for playback on the device. These capabilities are integrated into a device that in the “best case” is only capable of performing virtual stereo audio output.

One special capability of the present invention resides in the capability to select or generate certain audio channels for playback and to abandon the audio data of the other audio channels. Considered alone, the embodiment provides only a fraction of all available audio data with a waste of a lot of battery and processing resources. It should be noted that in one example embodiment the audio playback device is a battery (or solar cell) powered mobile portable or even handheld audio output/playback device. Depending on the form in which the audio data are actually provided (as an analogue audio stream or as digitally coded data), the device may be considered as a kind of active signal processing satellite speaker or as a music player device with active signal processing capabilities.

In another example embodiment of the present invention, said audio playback device is a first audio playback device. In the first audio playback device said obtaining means is configured for obtaining also second channel audio data from said multi-channel audio data. The second channel audio data are for playback on at least one external second audio playback device. The first audio playback device is further provided with transfer means, connected to said obtaining means for transferring said obtained second channel audio data to said at least one second audio playback device for playback.

This embodiment extends the capabilities of a second audio playback device to the capabilities of a first audio playback device as described in the preceding description. The “extended capabilities second audio playback device” selects/generates a number of audio channels, selects one or a few of them for direct playback and the others to be sent to external devices for remote playback.

In just another example embodiment said audio playback device is again a first audio playback device that further comprises transfer means. The transfer means is connected to said receiving means for transferring received multi-channel audio data to at least one second audio playback device. In this embodiment the second audio device(s) may obtain and play back second channel audio data from said transferred multi-channel audio data.

In contrast to the above embodiment, this embodiment forwards all received audio data to one or more second audio devices to enable a kind of “audio channel self service” for the playback of the audio data at the second devices.

The above two embodiments may be considered as the first audio playback device extensions of a second audio playback device.

In yet another example embodiment of the present invention, the audio playback device further comprises a user interface connected to said obtaining means for receiving an input indicative of which channel(s) of said multi-channel audio data is to be obtained as said first channel audio data. In this embodiment the obtaining means is configured to obtain said first channel audio data according to said received input. That is, a user can select via display/buttons or a RF connection which channel (or which channels) a certain device should use for play back. This may be embodied as menu wherein a user may select e.g. the right rear channel of a 5.1 surround sound system for playback on the device. A similar solution may also be selected for playback with a device connected e.g. via a Bluetooth connection, wherein a user can allocate certain channels to certain playback devices via Bluetooth. In yet another example embodiment, the user interface is provided for input indicative of which channel(s) of said multi-channel audio data is to be obtained as said second channel audio data.

In just another example embodiment of the present invention, said obtaining means comprises a selector to select said first and/or second channel audio data from said received multi-channel audio data. The selector is provided to enable a selection of a certain channel of multi-channel audio data for playback. The selector can be used to simply select one of a plurality of received audio channels of a multi-channel audio data (such as a 5.1 or 7.1 surround sound data stream). This embodiment is especially useful for the use in case that the number of available playback devices at least equals the number of available audio channels. In this system a user may allocate each device one audio channel. If more then e.g. 6 devices are available for playback it is for example possible to allocate e.g. subwoofer channel to 2 or 3 of 5 devices to improve the bass playback functionality. Additionally if e.g. 12 devices can be used in a 5.1 sound system, each channel may be played back with two devices.

In another example embodiment of the present invention, said obtaining means comprises a generator to generate said first and/or second channel audio data from said received multi-channel audio data. This embodiment is directed to a terminal device with the capability of generating (at least certain) audio channels from received or retrieved multi-channel audio data. This embodiment is e.g. capable of generating new audio channels from received multi-channel audio data. This may be embodied as a kind of e.g. 5.1 decoder capable of decoding coded multi-channel audio data. This may also be embodied as a kind of 4.1 “LCRRS” generator from e.g. 5.1 multi-channel data by combining the two rear channels of 5.1 to the single rear channel of LCRRS. This embodiment can be used to adapt each number of available channels to each number of actually available audio playback devices for multi-channel audio playback. This special embodiment also enables the use of a distributed channel generation system, wherein at each terminal device only one audio output channel is generated. Such an implementation can relieve a single device from task of generating all single audio channels for each one of the connected playback devices. This implementation can be used to transfer all multi-channel audio data to (a few or) each connected audio playback device so that each device may generate its own audio playback channel. This implementation can be used to implement a kind of distributed computing to keep the calculation load for each single device low to prevent that a single device has to take all the load of generating (compressing) and distributing (sending) all audio tracks and additionally being burdened with outputting its own audio track at the same time with the restricted capabilities of a portable device such as a mobile telephone.

In another example embodiment the audio playback device is further provided with a decompressor or a decompression unit to decompress received audio data. This embodiment is especially useful if a data compression technique is used e.g. to reduce the bandwidth of an (single channel or multi-channel) audio data transmission. It is for example envisaged to use decompression to reduce the bandwidth when receiving audio data e.g. from a storage as a DTS surround sound-, DVD-Audio- (DVA-), Hyper CD-, MP3-, .ogg-, .wav-, aif-, .aiff-, .au-, .wma-, .ra-, ram-, RealAudio-, AAC-, .m4a- and/or, AC3-coded data stream (in a first audio playback device). It is also contemplated to use decompression to reduce the bandwidth when receiving audio data (e.g. single channel audio data from a first playback device) at a (second) playback device as e.g. an MP3 . . . -coded audio data stream.

In yet another example embodiment of the present invention a playback device is provided with a compressor to compress audio data to be transferred. This embodiment is suitable for (first) audio playback devices that actually generate certain audio channels to be sent to other devices connected e.g. via Bluetooth. This embodiment may also be used to transfer all multi-channel audio data to all connected audio playback devices for the de-centrally executed extraction of single audio channels from the multi-channel audio data.

In another example embodiment of the present invention said audio playback device further comprises an audio data storage connected to said receiving means, for receiving said multi-channel audio data from said audio data storage. An additional internal audio data storage provides an audio player capability to the playback device, enabling the playback of certain tracks directly on the player device and the transfer of other tracks to other e.g. wirelessly connected audio playback devices. It is also envisaged to use audio data storage to buffer received audio data for decompression, synchronization or audio channel extraction tasks.

In another example embodiment of the present invention, said audio playback device further comprises a synchronizing means for synchronizing the audio playback of said first and second channel audio data on said first and second audio playback devices. The synchronizing means may be embodied as a number of delay elements provided to delay the transmission of single audio channels to remote audio playback devices to compensate for different data processing times and audio data to audio output conversion delays of different (second) audio playback devices.

In yet another example embodiment said audio playback device is further provided with a synchronization unit connected to said obtaining means for providing said obtained first and second channels audio data with synchronization marks. The synchronization marks can be used to synchronize e.g. the playback of audio data (sections) with e.g. the hopping sequence of Bluetooth frequency hopping algorithm. With this embodiment it is possible to use e.g. time stamps to enable synchronized playback of each of the generated audio channels. It should be noted that even in case that all multi-channel audio data are transferred these multi-channel audio data may be provided with synchronization markers (e.g.) timestamps to enable synchronized playback even in the special case that the single channels are obtained in a distributed manner.

In an example embodiment of the present invention said receiving means comprises a Bluetooth module. It is also envisaged that the receiving means comprises a WLAN module. It is also contemplated to provide the receiving means with an infrared receptor. It is also contemplated to provide the receiving means with wire interface to receive audio data via a cable connection. The receiving means may be embodied as a receiver, or a receiver module, or as a receiver combination. It is also contemplated to combine the transfer means and the receiver means to combined transceivers.

In another example embodiment of the present invention said transfer means comprises a Bluetooth module. It is also envisaged that the transfer means comprises a WLAN module. It is also contemplated to provide the transfer means with an infrared sender/receptor. It is also contemplated to provide the transfer means with wire interface to transfer/transmit audio data via a cable connection. The transfer means may be embodied as a transmitter, a transmitter module, or as a transmitter combination.

In another example embodiment, said audio playback device is incorporated in an audio playback enabled mobile or cellular phone or comprises a mobile or a cellular telephone. This implementation is directed to a device with the capability of playing back audio data/files directly via at least one built-in speaker. The telephone with the desired capabilities may be embodied as music playback enabled mobile phone with e.g. the capability to play back stored audio files via a built-in speaker. It is also envisaged to implement the device as an audio player (such as a fully electronically operated MP3-player) with additional audio playback capabilities. This embodiment may also be implemented as a Bluetooth and audio output enabled communicator with a clamshell design a QWERTY-keyboard and a capability to performing acoustic output via e.g. a hands-free speaker of the mobile telephone.

In still another example embodiment, said audio playback device is further provided with a processing unit and a user input/output interface. The processing unit is provided for executing game software and is connected to said receiving means for transferring multi-channel game audio data to said receiving means. The user input/output interface connected to said processing unit for providing user interaction with said executed game. This embodiment can be used to output game music and game sound as surround sound via an external sound system provided by a number of external audio playback devices. In this implementation the center speaker shall be in the mobile/portable/handheld gaming device where the associated content e.g. video or game is shown and from which the audio content is played.

This embodiment may be implemented as a mobile game-phone such as Nokia's N-GAGE that serves as a first device, provides a multi-channel audio stream or different audio channels via Bluetooth to other second audio playback devices such as e.g. playback enabled mobile telephones, MP3-players, other N-Gages or the like.

It may however be implemented as another topology by connecting a mobile game device with external playback device to transfer all multi-channel audio data to a first audio device for example via a cable connection. In such an implementation the first connected audio playback device performs the method of the present invention of playing back one track and splitting up or distributing and the multi-channel audio data received from the gaming device. This embodiment also comprises the implementation of a gaming device with the capability of outputting multi-channel audio data for playback via connected multi-audio playback device-sound-system. This embodiment has the advantage that the single mobile game device has not to take care of providing and distributing the audio data. Therefore, the game device may use all its processing power to execute the game software. This implementation is a novel approach for adding multi-channel sound support to mobile games. The center audio channel can be played using mobile phone's own loudspeaker(s), while other channels are played using the external multi-channel sound system. Using e.g. a cable or streaming the data wirelessly over Bluetooth or WLAN builds the connection to the external system. Due to bandwidth restrictions the multi-channel audio data may have to be efficiently compressed.

According to another example embodiment of the present invention, said audio playback device further comprises a display and may serve as an audio video playback device. In contrast to the above embodiments all components of the device are capable of handling video data in addition to audio data. For example said receiving means is configured for receiving multi-channel audio/video data, said obtaining means is configured for obtaining first channel audio/video data from said multi-channel audio/video data for playback on said audio playback device, and said playback means having at least one loudspeaker and a display, for outputting said first channel audio/video data. It should be clear that all other components of present invention disclosed only with respect to audio data are also capable of storing, receiving, handling, compressing, transferring, decompressing selecting, generating outputting (multi-channel) audio and/or video data.

There are more novel use cases unique to the mobile phone/handheld world. Most modern mobile terminals have keypad lights, mono/color display(s), browser, media/music player application, capability for interactive on-line user input during playback, camera(s), Java support, etc. These are enablers for creating new unique use cases. This implementation extends the method of operating a portable surround sound system to an “on-line mobile theatre” invention. It is for example envisaged to use the displays of all satellite phone devices to output the same video/display content. This application has the additional advantage that the device may be implemented as an Y.X video system wherein the satellite displays are only used to contribute to the ambient light while only one display actually shows the full video content. Each satellite speaker (audio/video playback device) may display visual effects via keypad lights & mono/color display(s). Each audio video playback device may display related multimedia information (metadata) like such as Visual Radio, for displaying Music text, the notes of a main /solo instrument or (in case of a sufficiently big display) the score, or e.g. for classic music only the notes of an instrument of interest (such as the second cello). Each display can have different visual effects/information displayed. In case of a MIDI-orchestra it may be contemplated to display the notes of all instruments emulated by a certain audio/video device on the display of this device in synchronously with that music playback.

It is also contemplated that each listener in this portable surround sound environment can interact on-line during playback. A user may browse e.g. audio & links to artist's/groups website (accessible via mobile's browser) during playback. This embodiment of the invention is similar to the “home theatre” when it comes to the concept of Mobile TV. For example, it is possible to create a “mobile surround sound/video theatre” using this invention. Some mobile terminals having a larger screen may be used as the main screen. It is also contemplated that forward facing (front) audio/video playback devices can have the screens playing the same video feed/stream. If “TV out” is available on a mobile terminal even a small portable TV can be used as the main screen (similar to an audio “Subwoofer”).

The option of interacting with the audio/video playback devices may be used for collaborative editing, or dynamic audio/music content playback. It is for example envisaged to enable a user to substitute different sound channels than one presented to the satellite speaker to play.

This implementation enables for example, local garage band to record one musical instrument per sound channel. During playback one of the sound channels may be replaced with new music to hear how the song sounds overall.

### BRIEF DESCRIPTION OF THE DRAWINGS

In the following, the invention will be described in detail by referring to the enclosed drawings.

FIG. 1 is a flowchart of a basic embodiment of a method for playing back audio data according to one aspect of the present invention.

FIG. 2 is a flowchart of another basic embodiment of a method for playing back audio data according to another aspect of the present invention.

FIG. 3 is an example of a method according to the present invention that combines steps of the methods of FIGS. 1 and 2.

FIG. 4 is another example of a method according to the present invention that extends the method of FIG. 1.

FIG. 5 depicts a flowchart of a more sophisticated method for playing back audio data on a plurality of audio playback devices according to the invention.

FIG. 6 depicts a block diagram of a basic embodiment of audio playback device according to the present invention.

FIG. 7 is a block diagram of another basic embodiment of an audio playback device according to the present invention.

FIG. 8 depicts a combination of the audio playback devices of FIGS. 6 and 7.

FIG. 9 depicts an audio playback device that combines the abilities of the audio playback devices of FIGS. 6 and 7.

FIG. 10 depicts a more sophisticated audio playback enabled mobile telephone gaming device.

FIG. 11 is an example of a system for distributed playing back the channels of multi-channel audio data.

FIG. 12 is an example of a system for distributed playing back the channels of multi-channel audio data.

FIG. 13 is an example of a four-channel audio sound system comprising four similar audio playback devices.

FIG. 14 is another example of a system for distributed playing back the channels of multi-channel audio data.

### DETAILED DESCRIPTION

In the detailed description that follows, identical components have been given the same references, regardless of whether they are shown in different embodiments of the present invention. In order to clearly and concisely illustrate the present invention, the drawings may not necessarily be to scale and certain features may be shown in somewhat schematic form.

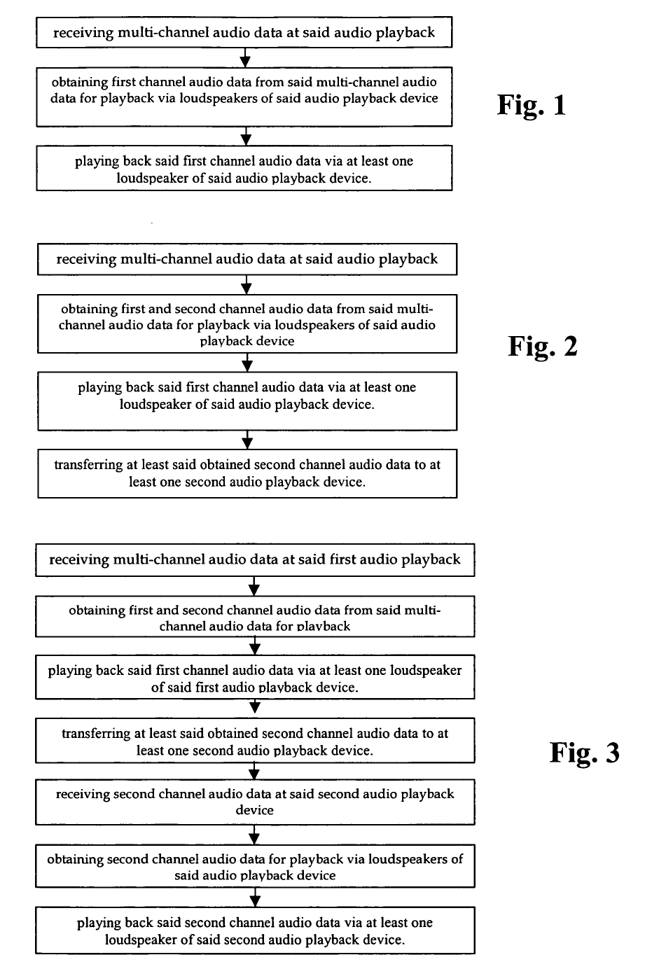

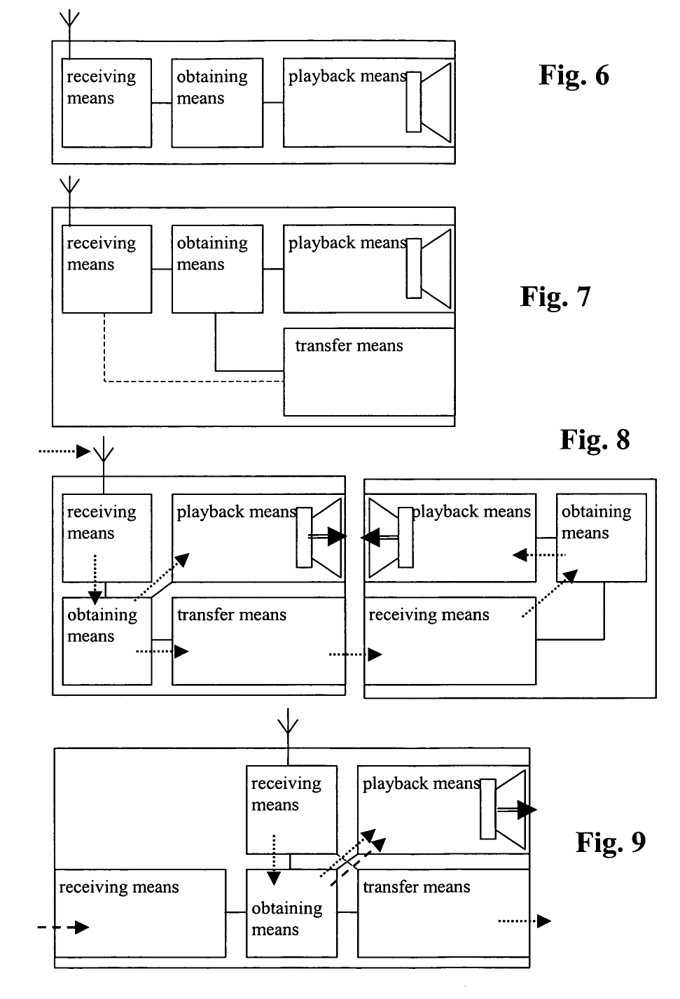

FIG. 1 is a flowchart of a basic embodiment of a method for playing back audio data according to one aspect of the present invention. The basic implementation comprises receiving multi-channel audio data at said audio playback device. In FIG. 1 it is not defined if the multi-channel audio data are received from an external device or e.g. from an internal storage or player component of the playback device. In a next step first channel audio data are obtained from said multi-channel audio data for playback via loudspeakers of said audio playback device. Finally the obtained first channel audio data are played back via at least one loudspeaker of said audio playback device. FIG. 1 depicts a simple method for playing back only one or two channels of received multi-channel audio data. This method may be executed by “second audio playback devices” as will be described in FIGS. 6, 8, 9. The method is extensible as will be shown in FIGS. 2 to 5.

FIG. 2 is a flowchart of another basic embodiment of a method for playing back audio data according to one aspect of the present invention. As in FIG. 1, the method starts with receiving multi-channel audio data at said audio playback device. In addition to the obtaining first channel audio data, second channel audio data is obtained from said multi-channel audio data. As in FIG. 1, the first channel audio data are played back via at least one loudspeaker of said first audio playback device. The obtained (at least one) second channel audio data are sent or transferred to at least one second audio playback device. This embodiment inherently comprises the playback of the second channel audio data via a second playback device and shows the feature of generating a surround sound effect with a number of substantially independent audio playback devices. In the embodiment of FIG. 2, one device generates all single audio tracks and distributes them to different remote playback devices.

FIG. 3 is an example of a method according to the present invention that combines steps of the methods of FIGS. 1 and 2. The method comprises receiving multi-channel audio data at said first audio playback device, obtaining first and second channel audio data from said multi-channel audio data for playback, playing back said first channel audio data via at least one loudspeaker of said first audio playback device and transferring at least said obtained second channel audio data to at least one second audio playback device. In addition to what is disclosed in FIG. 2, the method further comprises receiving said second channel audio data at said second audio playback device, obtaining second channel audio data for playback via loudspeakers of said audio playback device and playing back said second channel audio data via at least one loudspeaker of said second audio playback device.

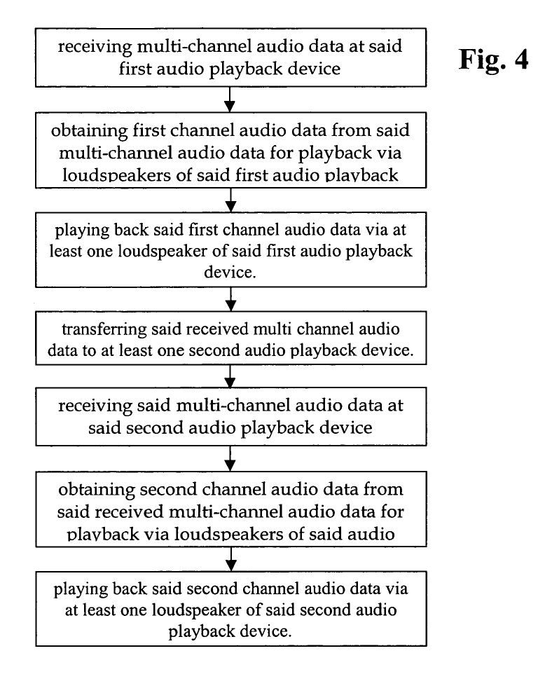

FIG. 4 is another example of a method according to the present invention that extends the method of FIG. 1. The method comprises all steps of FIG. 1 of receiving multi-channel audio data at said first audio playback device, obtaining first channel audio data from said multi-channel audio data for playback via loudspeakers of said first audio playback device and playing back said first channel audio data via at least one loudspeaker of said first audio playback device.

Additionally, transferring said received multi channel audio data to at least one second audio playback device extends the method. Then, the method of FIG. 1 is substantially repeated at (at least one) second audio playback device. The (at least one) second audio playback device receives said multi-channel audio data (at said second audio playback device), obtains second channel audio data from said received multi-channel audio data for playback via loudspeakers of said second audio playback device and plays back said obtained second channel audio data via at least one loudspeaker of said second audio playback device. In FIG. 4, each device extracts the audio data to be played back directly from the received multi-channel audio data.

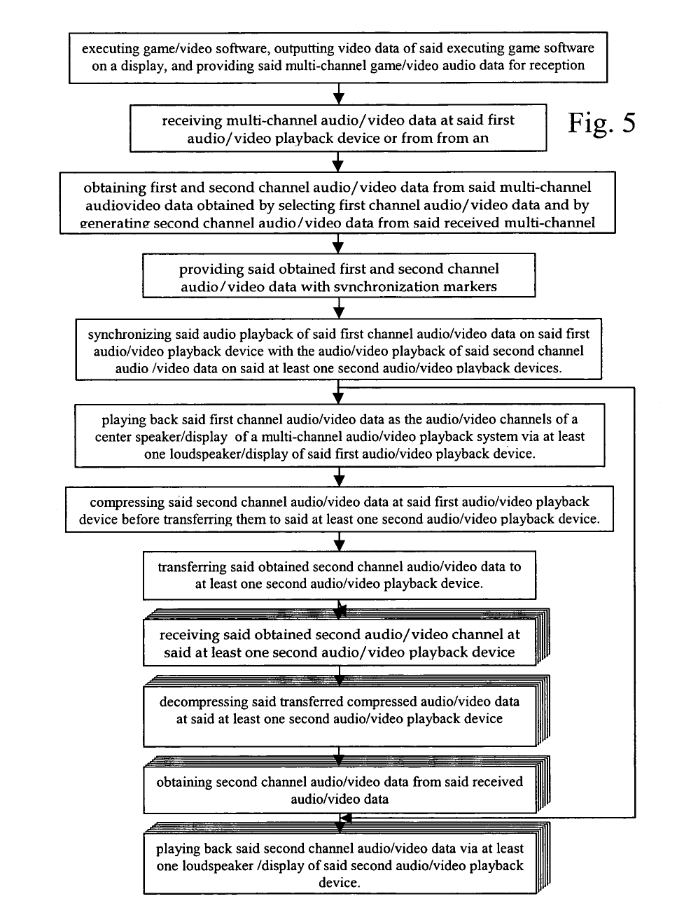

FIG. 5 depicts a flowchart of a more sophisticated embodiment of a method for playing back audio/video data on a plurality of audio/video playback devices according to the present invention. The method depicted in FIG. 5 is basically an extended version of the method of FIG. 3. In contrast to the method of FIG. 3 the audio/video data are received from executed game software. The execution of the game software comprises outputting video data of said executing game software on a display, and providing said multi-channel game audio/video data. The multi-channel audio/video data are received at said first audio/video playback device from an audio/video data storage (in this case form an input/output queue or indirectly from a storage storing said executed game software). FIG. 5 specifies that first and second channel audio/video data from said multi-channel audio/video data are obtained by selecting first channel audio/video data and by generating second channel audio/video data from said received multi-channel audio/video data for playback.

In addition to the method of FIG. 3, said obtained first and second channel audio/video data are provided with synchronization markers. The synchronization markers are finally used to synchronize said audio/video playback of said first channel audio/video data on said first audio/video playback device with the audio/video playback of said second channel audio/video data on said at least one second audio/video playback device.

As in FIG. 3, the first channel audio/video data are played back on said first audio/video playback device. The first channel audio/video data is specified as the channel of a center speaker of multi-channel audio/video playback system.

Before the transmission to said at least one second audio/video playback device said second channel audio/video data are compressed at said first audio/video playback device.

The obtained and compressed second audio/video channel audio/video data are received at said at least one second audio/video playback device, where they are obtained by decompressing. Finally the obtained second channel audio/video data are played back via at least one loudspeaker and at least one display of said second audio/video playback device.

FIG. 6 depicts a block diagram of a basic embodiment of audio playback device according to the present invention. In the basic embodiment the device comprises a receiving means for receiving multi-channel audio data, obtaining means for obtaining first channel audio data and playback means for playing back first channel audio data obtained by said obtaining means via a speaker of said playback means. The device of FIG. 6 is capable of executing the method of FIG. 1.

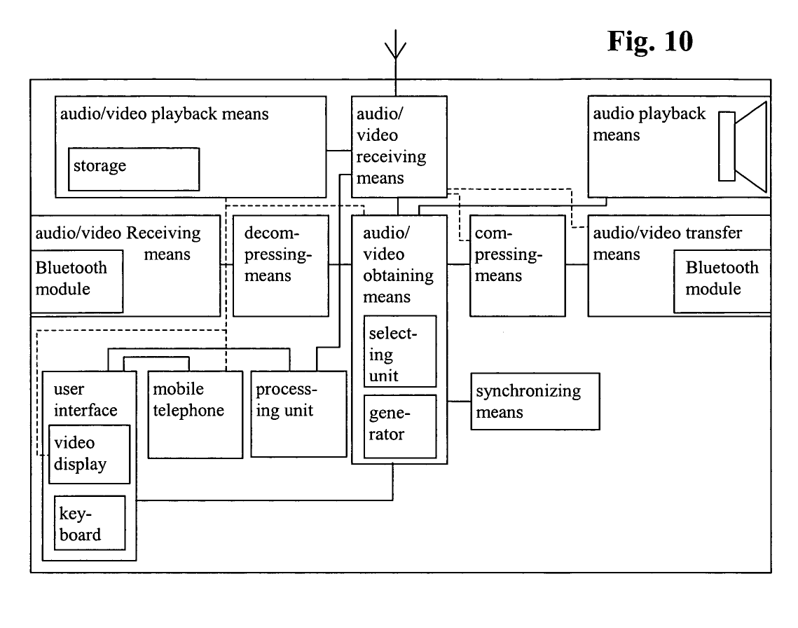

FIG. 7 is a block diagram of another basic embodiment of audio playback device according to the present invention. In addition to the device of FIG. 6, the device of FIG. 7 comprises an additional transfer means connected to said obtaining means. It is also envisaged to combine the transfer and said receiving means as a transceiving means. With this connection the audio playback device may be used to obtain second channel audio data and transfer them via the transfer means to second audio playback devices for playback (as depicted in FIGS. 2 and 3). In an alternative embodiment the transfer means is (via the dotted line) directly connected to receiving means to transfer received multi-channel audio data to a second playback device (as such as it is depicted in FIGS. 7 and 10).

FIG. 8 depicts a combination of the audio playback devices of FIGS. 6 and 7, ready to execute the method depicted in FIG. 3. In FIG. 8 the receiving means of the device depicted on the right side is depicted similarly to the transfer means to indicate that the transfer means of the device on the left side are designed to cooperate with each other. In FIG. 8 the dotted arrows indicate the data is transfer between from the receiving means via the obtaining means to the playback means and to the transfer means. In FIG. 8 the dotted arrows also indicate data transfer from the transfer means via the receiving means said obtaining means to the playback means of the device on the right side. The double lined arrows indicate an audio output.

FIG. 9 depicts an audio playback device that combines the abilities of the audio playback devices of FIGS. 6 and 7. The depicted device comprises two receiving means. One receiving means is designed to cooperate with a transfer means of another similar audio playback device (to receive second channel audio data, or to receive first channel audio data). The other receiving means is designed to receive multi-channel audio data from an arbitrary audio data source (indicated with an antenna). The device may be used as any device depicted in FIGS. 6 to 8. The device may be used to perform the methods depicted in FIGS. 1 to 4. As in FIG. 7, a direct connection (indicated by a dotted line) between the transfer means and the receiving means may serve to transfer received multi-channel audio data to a second playback device. In FIG. 9 the dotted arrows indicate the data flow in case of an operation as the device of FIG. 7. In FIG. 9 the dashed arrows indicate the data flow in case of an operation as the device of FIG. 7. As in FIG. 8, the double lined arrow indicates audio output.

FIG. 10 depicts a more sophisticated audio/video playback enabled mobile telephone gaming device. In principle the depicted device is the device of FIG. 9 extended by a few additional elements. The transfer and receiving means are provided with Bluetooth modules. Between the obtaining means and the transfer and receiving means, respectively there are compressing and decompressing means inserted. The obtaining means is depicted as comprising a selector and a generator to select or generate single audio/video channels from multi-channel audio/video data received via the one of the receiving means (the one with the Bluetooth module and the one with the indicated antenna). The obtaining means is also connected to a synchronizing means that is provided to enable synchronized playback and provide synchronization markers for enabling synchronized playback. The device is depicted as comprising audio/video playback means with an indicated audio/video data storage for providing multi-channel audio/video data via the receiving means to said obtaining means. The audio/video playback means may be embodied as a tape player, a digital audio/video player such as a CD player or MP3, DivX, DVD, S-video, DVB-H/-T/-S, OGG or the like compressed audio/video-format data player.

The device of FIG. 10 is also provided with a user interface connected to said obtaining means to select first channel audio/video data for playback via the playback means. The user interface is also provided to select second channel audio/video data/or multi-channel audio/video for transfer to other (second) audio/video playback devices.

The user interface is provided with a display and a keyboard for user interaction.

The device of FIG. 10 is also provided with a mobile telephone (module) connected to said user interface (which may also comprise a microphone and a speaker/earpiece). With the interface and the telephone component the device may provide full mobile communication operability. It is also envisaged to use the playback means e.g. as a speaker of the telephone in a hands-free operation mode. A user may interact with the mobile telephone via the display and keyboard of the user interface for dialing and taking telephone calls, sending and receiving short messages and the like. The mobile or cellular telephone module is also connected (via the dotted line) to the audio/video playback means. This combination provides a combined audio/video player phone operability to the audio/video playback device.

The device of FIG. 10 is also provided with a processing unit connected to said user interface (which in this case could also comprise a microphone and possibly also a speaker). With the interface and the user may control software programs executable or executed on said processing unit. It is for example possible to execute video game software on said processing unit. The executed software may be controlled via a keyboard, joysticks or other interface means of said user interface. The processing unit is connected to said receiving means to enable multi-channel audio/video output via distributed (second) audio/video playback devices. It should be clear the device depicted in FIG. 10 might emulate all of the audio/video playback devices depicted in FIGS. 6 to 9. It is also noted that the device of FIG. 10 is capable of executing the methods depicted in FIGS. 1 to 5.

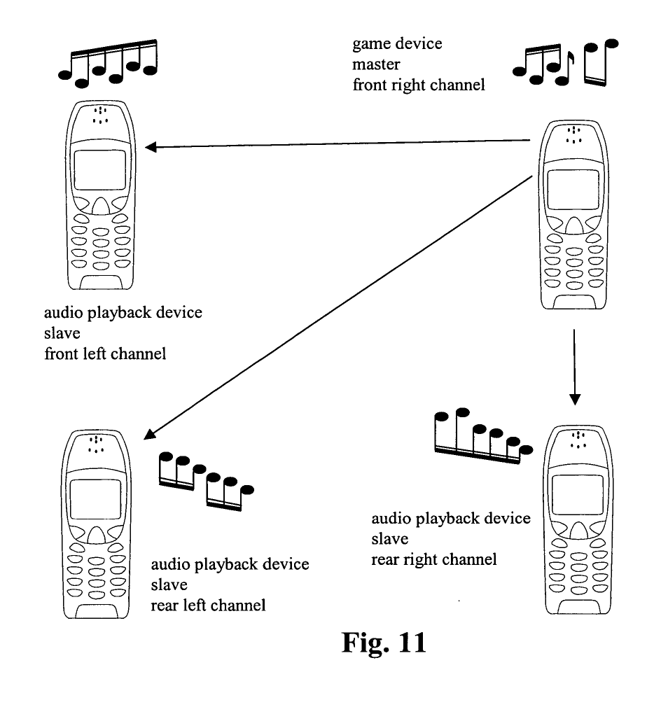

FIG. 11 depicts a first system for distributed playing back the channels of multi-channel audio data. The playback system comprises a number of substantially similar playback devices such as audio playback enabled mobile phones. A master/slave wireless network connects the comprised audio playback devices. The set up of the network may be implemented by using e.g. a “share” feature in the audio/music playback menu of the master device, which would automatically scan for other devices able to participate by Bluetooth or utilizing the magic-touch RFID technique after such a sharing. After setting up the contact, the selected audio data/playlist/digitally coded (e-g-MP3) music piece could be transferred and played back. The playback may be started with a master/slave relationship between the initiator (master) and the followers (slaves). A short selection of left and right/front rear channels could be optional, and maybe displayed stating the selected mode. The feature should be easy to reverse, so that others in the group of playback devices could counter-act and launch music from their own collection. That is the master device may tap the music files of connected audio slave devices for common playback. The figure shows in the top right a master phone transmitting a selected tune to the participating other phones in the group, synchronizing the playback of single channels on each of the phones to provide full Quattro audio playback.

It should explicitly be noted that the audio data maybe transferred completely to the second playback devices before the synchronized playback is started on each of the devices.

Mobile terminals can play back surround sound music content. In the depicted structure one mobile terminal (the master device) acts as music server and handles synchronization. The depicted system uses completely wireless connectivity between mobile terminals. In the depicted embodiment a powered sub-woofer is not required, but bass (music beat) does add to the ambience by each of the devices. It is also envisaged to use a dedicated mobile terminal as master terminal, i.e. for providing audio but not playing any music, if the power consumption is to high to additionally output the acoustic audio signal or if network architecture requires to many terminal resources.

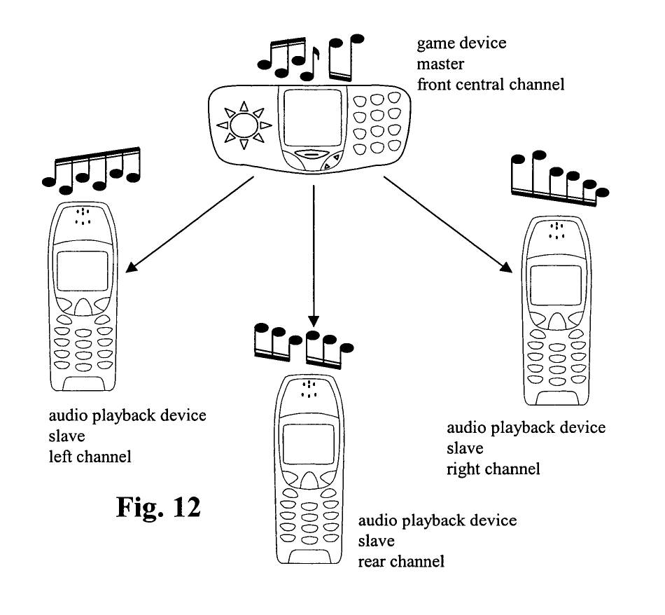

FIG. 12 depicts another application wherein a gaming device serves as master of surround sound audio playback system using a “LCRR” (Left Center Right Rear) audio playback system. The system is basically a “trimmed-down” version of a 5.1 sound system, wherein the subwoofer has been economized and the rear speakers have been combined to a single rear speaker. In the depicted system the master device is a gaming console (or a gaming enabled cellular phone) playing back the center channel of audio output of an executed gaming application.

It should be clear that the depicted system can be used for all kind of multi-channel audio playback, such as 4.1 systems (4 speakers, 1 sub-woofer), 5.1, 7.1 surround sound speaker configurations include or future 8.3 or 9.2 (Center/left/right, upper/lower, front/rear speaker) surround sound configurations.

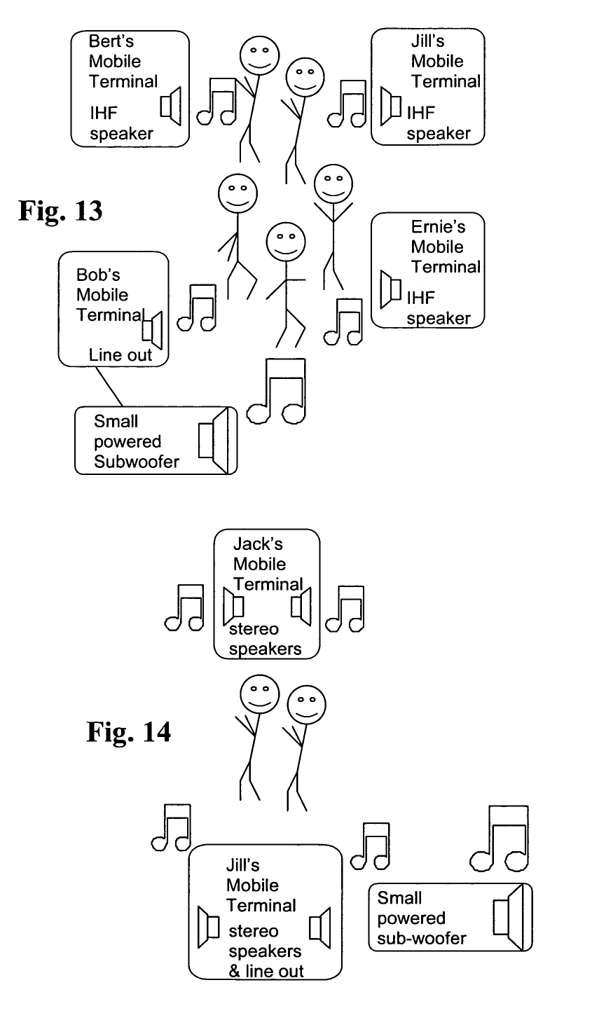

FIG. 13 depicts another version of the audio playback system of FIG. 11. In FIG. 13 the master device is provided with an additional cable connected small powered sub woofer. In this embodiment the master device (Bob's mobile terminal) generates two first audio channels (front right and subwoofer) for playback. The slave playback devices (Bert's, Jill's, and Ernie's mobile terminals) server to playback each a single channel of a multi-channel audio data provided by the master device (Bob's terminal). One of the terminals handles the audio playback (in the simplest case the master device Bob's terminal). The powered sub-woofer may not be necessary, but can add bass to the ambience.

FIG. 14 depicts another version of the audio playback system of FIG. 11 with only two playback devices and a wirelessly connected powered sub-woofer. In contrast to the implementation of FIG. 11 the master device (Jill's mobile terminal) and the mobile slave device (Jack's mobile terminal) both are capable of outputting two channels simultaneously. That includes that mater device may generate two first audio channels for direct playback and two second audio channels for playback via the slave device (Jack's mobile terminal. In contrast to the other embodiments the slave device receives at least the data of two audio channels and plays back both channels. In combination with the additional second audio channel transferred to the powered subwoofer, the master audio playback device may generate three second audio channels.

With the present invention, additional applications and audio surround sound effects may be added to mobile terminal devices. Audio has a major role in many computer applications such as games. It helps to make a right atmosphere for gaming and emphasizes actions on the screen. During the last few years, more and more games have started to use multi-channel sound. In the case of mobile phones, it has only be possible to wear headphones and use 3D audio processing to generate a sound world surrounding the listener.

Another alternative has been to connect the phone to an external multi-channel sound system using e.g. a cable.

This invention suggests that the center audio channel should be played using mobile phone's (gaming device's) own loudspeaker(s) or headphones (e.g. for information intended only for the player to hear). Other channels are played using the external multi-channel sound system provided by satellite audio player devices.

The sound volume of all speakers of all terminals has to be adjusted according to the position and distance of the respective speakers to the listener. Additionally, different amplification parameters of the possibly different playback devices have to be adapted to achieve a suitable surround sound experience. This could be done automatically or by the user.

The present invention also allows the generation of interesting, new kind of sound worlds with mobile devices. As an example, the external speakers could be used for playing ambient, environmental, etc. sound surrounding the player from every direction. The speaker of the mobile terminal could generate the dialogue and game events happening in the vicinity of the avatar the player is controlling. As an example, sounds of avatar's movements, part of the gunshots, etc. could be played by the mobile terminal. With the present invention a user may experience the sound of e.g. ricochets when playing a mobile shooter game. With the present invention a user may experience the sound of e.g. a trailing plane when playing a flight simulation game.

From the latency point of view it is also beneficial to render the real time effects directly on the terminal instead of transmitting to the external audio device, which may be achieved by coding and compressing of the transmission of audio sounds. Moreover, most of this latency could be compensated in the game logic for background sounds but not for effects since the evolution of background sounds can be predicted rather well for a short duration.

The expression multi-channel audio data refer to audio data that comprises a plurality of audio channels that are destined to be played back simultaneously.

This application contains the description of implementations and embodiments of the present invention with the help of examples. A person skilled in the art will appreciate that the present invention is not restricted to details of the embodiments presented above, and that the invention can also be implemented in another form without deviating from the characteristics of the invention. The embodiments presented above should be considered illustrative, but not restricting. Thus the possibilities of implementing and using the invention are only restricted by the enclosed claims. Consequently various options of implementing the invention as determined by the claims, including equivalent implementations, also belong to the scope of the invention.

What is claimed is:

1. A method for playing back audio data on an audio playback device such as an audio playback enabled mobile phone, said method comprising:
receiving multi-channel audio data at said audio playback device,
obtaining first channel audio data from said multi-channel audio data for playback via loudspeakers of said audio playback device, and
playing back said first channel audio data via at least one loudspeaker of said audio playback device.

2. The method for playing back audio data, according to claim 1, further comprising receiving an input indicating of which channel of said multi-channel audio data is to be obtained, and obtaining said first channel audio data from said multi-channel audio data accordingly.

3. The method for playing back audio data according to claim 1, wherein said audio playback device is a first audio playback device, the method further comprising:
obtaining at least second channel audio data from said multi-channel audio data, and
transferring at least said obtained second channel audio data to at least one second audio playback device.

4. The method for playing back audio data according to claim 3 wherein said first channel audio data played back via at least one loudspeaker of said first audio playback device is the audio channel of a center speaker of a multi-channel audio playback system.

5. The method for playing back audio data on audio playback devices such as an audio playback enabled mobile phone, according to claim 3, wherein said mobile phone being part of an audio playback system, comprising at least two audio playback devices, wherein said method further comprises:
outputting said second channel audio data with said at least one second audio playback device.

6. The method for playing back audio data on an audio playback device such as an audio playback enabled mobile phone according to claim 1, further comprising:
transferring said received multi-channel audio data to at least one second audio playback device.

7. The method for playing back audio data on audio playback devices of an audio playback system according to claim 6, said method further comprising:
obtaining at least one second channel audio data from said transferred multi-channel audio data at said at least one second playback device, for playback on said at least one second audio playback device, and
outputting said second channel audio data with said at least one second audio playback device.

8. The method for playing back audio data on an audio playback device according to claim 1, wherein said first/second channel audio data are obtained by selecting said first/second channel audio data from said received multi-channel audio data.

9. The method for playing back audio data on an audio playback device according to claim 1, wherein said first/second channel audio data are obtained by generating said first/second channel audio data from said received multi-channel audio data.

10. The method for playing back audio data on an audio playback system according to claim 1, wherein said multi-channel audio data are received in said first audio playback device from an audio data storage.

11. The method for playing back audio data on an audio playback system according to claim 5, further comprising synchronizing said audio playback of said first channel audio data on said first audio playback device with the audio playback of said second channel audio data on said at least one second audio playback devices.

12. The method for playing back audio data on an audio playback system according to claim 3, further comprising providing said obtained first and second channels audio data with synchronization markers.

13. The method for playing back audio data on an audio playback system according to claim 3, further comprising compressing said audio data at said first audio playback device before transferring them to said at least one second audio playback device.

14. The method for playing back audio data on an audio playback system according to claim 1, further comprising decompressing said transferred compressed audio data at said at least one second audio playback device.

15. The method for playing back audio data on an audio playback system according to claim 3, further comprising executing game software, outputting video data of said executing game software on a display, and providing said multi-channel game audio data as said received multi-channel audio data.

16. The method for playing back audio data on an audio playback system according to claim 3, further comprising receiving display information, outputting display information on a display, and transferring display information to other devices.

17. A computer program product for executing a method capable of playing back audio data on an audio playback device or system, comprising program code sections stored on a machine-readable medium for carrying out the steps of claim 1, when said program product is run on a controller, processor-based device, a computer, a microprocessor based device, a terminal, a network device, a mobile terminal, or a mobile communication enabled terminal.

18. A software tool capable of playing back audio data on an audio playback device or system, comprising program portions for carrying out the operations of claim 1, when said program is implemented in a computer program for being executed on a controller, processor-based device, a microprocessor based device, processing device, a terminal device, a network device, a mobile terminal, or a mobile communication enabled terminal.

19. A computer data signal embodied in a carrier wave and representing instructions, which when executed by a processor cause the steps of claim 1 to be carried out.

20. An audio playback device, comprising:
receiving means for receiving multi-channel audio data,
obtaining means connected to said receiving means, for obtaining first channel audio data from said multi-channel audio data for playback on said audio playback device,
playback means having at least one loudspeaker, and being connected to said obtaining means for outputting said first channel audio data.

21. The audio playback device according to claim 20, wherein said audio playback device is a first audio playback device, wherein said obtaining means is configured for obtaining also second channel audio data from said multi-channel audio data, for playback on at least one external second audio playback device, wherein said first audio playback device further comprises
transfer means, connected to said obtaining means for transferring said obtained second channel audio data to said at least one second audio playback devices for playback.

22. The audio playback device according to claim 20, wherein said audio playback device is a first audio playback device, further comprising
transfer means, connected to said receiving means for transferring received multi-channel audio data to at least one second audio playback device for obtaining and playback of second channel audio data from said transferred multi-channel audio data at said at lest one second audio playback device.

23. The audio playback device according to claim 20 further comprising a user interface connected to said obtaining means for receiving an input indicative of which channel of said multi-channel audio data is to be obtained as said first channel audio data, and wherein said obtaining means is configured to obtain said first channel audio data according to said received input.

24. The audio playback device according to claim 20 wherein said obtaining means comprises a selector to select said first and/or second channel audio data from said received multi-channel audio data.

25. The audio playback device according to claim 20 wherein said obtaining means comprises a generator to generate said first and/or second channel audio data from said received multi-channel audio data.

26. The audio playback device according to claim 20 further comprising a decompressor to decompress received audio data.

27. The audio playback device according to claim 21 further comprising a compressor to compress audio data to be transferred.

28. The audio playback device according to claim 20 further comprising an audio data storage connected to said receiving means, for receiving said multi-channel audio data from said audio data storage.

29. The audio playback device according to claim 20, further comprising a synchronizing means for synchronizing the audio playback of said first and second channel audio data on said first and second audio playback devices.

30. The audio playback device according to claim 20, further comprising a synchronizing unit connected to said obtaining means for providing said obtained first and second channel audio data with synchronization marks.

31. The audio playback device according to claim 20, wherein said receiving means comprises a Bluetooth module.

32. The audio playback device according to claim 21, wherein said transfer means comprises a Bluetooth module.

33. The audio playback device according to claim 20 wherein said audio playback device is an audio playback enabled mobile telephone phone.

34. The audio playback device according to claim 21 further comprising
a processing unit for executing game software, connected to said receiving means for transferring multi-channel game audio data to said receiving means, and
a user input/output interface connected to said processing unit for providing user interaction to said executed game.

35. The audio playback device according to claim 21, further comprising a display, and wherein said receiving means is configured for receiving multi-channel audio/video data, said obtaining means is configured for obtaining first channel audio/video data from said multi-channel audio/video data for playback on said audio playback device, and said playback means having at least one loudspeaker and a display, for outputting said first channel audio/video data.
